(19) United States
(12) Patent Application Publication
(10) Pub. No.: US 2012/0246410 A1
(43) Pub. Date: Sep. 27, 2012

(54) CACHE MEMORY AND CACHE SYSTEM

(75) Inventor: Hui Xu, Kawasaki-shi (JP)

(73) Assignee: KABUSHIKI KAISHA TOSHIBA, Tokyo (JP)

(21) Appl. No.: 13/156,471

(22) Filed: Jun. 9, 2011

(30) Foreign Application Priority Data
Mar. 24, 2011 (JP) 2011-066317

(51) Int. Cl. G06F 12/08

(52) U.S. Cl. 711/128; 711/E12.018; 711/E12.022; 711/E12.026

(57) ABSTRACT

A cache memory has one or a plurality of ways having a plurality of cache lines including a tag memory which stores a tag address, a first dirty bit memory which stores a first dirty bit, a valid bit memory which stores a valid bit, and a data memory which stores data. The cache memory has a line index memory which stores a line index for identifying the cache line. The cache memory has a DBLB management unit having a plurality of lines including a row memory which stores first bit data identifying the way and second bit data identifying the line index, a second dirty bit memory which stores a second dirty bit of bit unit corresponding to writing of a predetermined unit into the data memory, and a FIFO memory which stores FIFO information prescribing a registered order. Data in a cache line of a corresponding way is written back on the basis of the second dirty bit.

### CROSS-REFERENCE TO RELATED APPLICATION

This application is based upon and claims the benefit of priority from the prior Japanese Patent Application No. 2011-66317, filed on Mar. 24, 2011, the entire contents of which are incorporated herein by reference.

### BACKGROUND

1. Field

Embodiments described herein relate generally to cache memory and cache system.

2. Background Art

Conventionally, in a cache system of an ordinary write back scheme, a flash instruction is executed to assure that data written into the cache memory is reflected to an external memory. The flash instruction checks a dirty bit in a specified cache line, and writes back data in the cache memory to the external memory if the dirty bit is dirty. If flash instructions are executed consecutively, a core cannot execute the next flash instruction until the preceding write back is completed.

Therefore, there is also a method in which the cache memory automatically writes back a cache line having a dirty bit which has already become dirty, in parallel with arithmetic operation processing in the core.

In this method, however, an ordinary cache system has a dirty bit only by taking a cache line as the unit. Even if there is still a clean byte, therefore, the write back is automatically conducted, resulting in a possibility of wasteful dissipation of the bandwidth.

Against such a problem, for example, a method of managing the dirty bits by taking a half or a quarter of a line as the unit is conceivable. In this case, however, there is a problem that the number of bits of the dirty bit becomes enormous and the area of the cache memory becomes large.

### BRIEF DESCRIPTION OF THE DRAWINGS

FIG. 1 is a diagram showing a configuration example of a cache system 100 according to an embodiment of the present invention;

FIG. 2 is a diagram showing a configuration example of the cache memory 2;

FIG. 3 is a diagram showing a configuration example of the DBLB management unit 201;

FIG. 4 is a diagram showing a configuration example of a row memory 202 in the DBLB management unit 201;

FIG. 5 is a diagram showing an example of the case where the cache memory 2 is requested to conduct write access by the core 1 and the requested address has hit;

FIG. 6 is a diagram showing an example of pipeline processing conducted for the core 1 to access the cache memory 2 and pipeline processing in which the DBLB management unit 201 operates;

FIG. 7 is a diagram showing an example of pipeline processing conducted for the core 1 to access the cache memory 2 and pipeline processing in which the DBLB management unit 201 operates;

FIG. 8 is a diagram showing an example of operation when the cache line which has hit in the cache memory 2 does not exist even if retrieval is conducted in the DBLB management unit 201;

FIG. 9 is a diagram showing an example of operation of the DBLB management unit 202 when a cache miss has occurred;

FIG. 10 is a diagram showing another example of pipeline processing in which the core 1 accesses the cache memory 2 and pipeline processing in which the DBLB management unit 201 operates;

FIG. 11 is a diagram showing the another example of pipeline processing conducted for the core 1 to access the cache memory 2 and pipeline processing in which the DBLB management unit 201 operates; and

FIG. 12 is a flow chart showing an example of operation of the cache memory 2 in the present invention.

### DETAILED DESCRIPTION

A cache memory according to an embodiment, comprises one or a plurality of ways having a plurality of cache lines including a tag memory which stores a tag address, a first dirty bit memory which stores a first dirty bit, a valid bit memory which stores a valid bit, and a data memory which stores data. The cache memory comprises a line index memory which stores a line index for identifying the cache line. The cache memory comprises a DBLB management unit having a plurality of lines including a row memory which stores first bit data identifying the way and second bit data identifying the line index, a second dirty bit memory which stores a second dirty bit of bit unit corresponding to writing of a predetermined unit into the data memory, and a FIFO memory which stores FIFO information prescribing a registered order. Data in a cache line of a corresponding way is written back which is controlled by DBLB on basis of the second dirty bit.

Hereafter, a cache memory according to the present invention will be described more specifically with reference to the drawings.

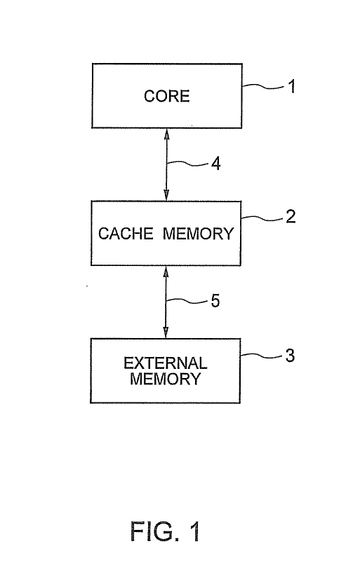

FIG. 1 is a diagram showing a configuration example of a cache system 100 according to an embodiment of the present invention. The cache system 100 includes a core 1, a cache memory 2, an external memory 3, and buses 4 and 5.

The core 1 executes software instructions such as a flash instruction, a write access instruction and a read access instruction. The cache memory 2 is connected to the core 1 via the bus 4. The external memory 3 is connected to the cache memory 2 via the bus 5.

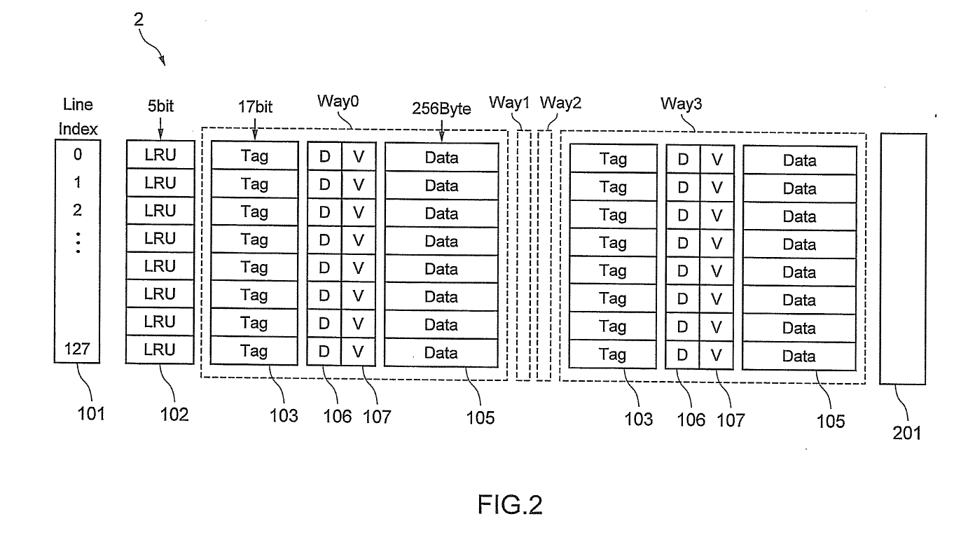

FIG. 2 is a diagram showing a configuration example of the cache memory 2. The cache memory 2 is typically formed by using an SRAM which is smaller in capacity and faster in speed than a storage device of a lower level. The cache memory 2 has a structure in which a part of data main body and attribute information such as its address and flag are stored in a memory of a fixed capacity. There are a large number of architectures in its data structure, line replacement and data update schemes.

The cache memory 2 includes a plurality of ways each having a plurality of cache lines, a line index memory 101 which stores a line index for identifying a cache line, and a least recently used (LRU) memory 102. The cache memory 2 shown in FIG. 2 has a data storage structure formed of four set tags of a 4-way set associative scheme. Each way includes a tag memory 103 which stores tag addresses Tag, a dirty bit memory 106 which stores dirty bits D, a valid bit memory 107 which stores valid bits V, and a data memory 105 which stores 256-byte data.

It is now supposed that the cache memory 2 has a cache size of, for example, 128 KB. The cache memory 2 is formed of 128 cache lines. Tag addresses Tag each having 17 bits which are high order bits [31:15] (tag address part) of a line unit address having 32 bits are stored in the tag memory 103. Upon receiving an access request from the core 1, the cache memory 2 compares a tag address part of a retrieval entry address with a tag address Tag stored in the tag memory 103, and judges a cache hit.

Cache line replacement (refilling) occurs when all cache lines of a pertinent entry address have data stored therein, a new tag address of the same entry is input, and a cache miss has occurred (that is, a cache hit has not occurred). In this case, for example, an LRU algorithm is used to determine which cache line should be excelled and replaced by a new address. The LRU algorithm is a method of refilling a cache line accessed the most earlier.

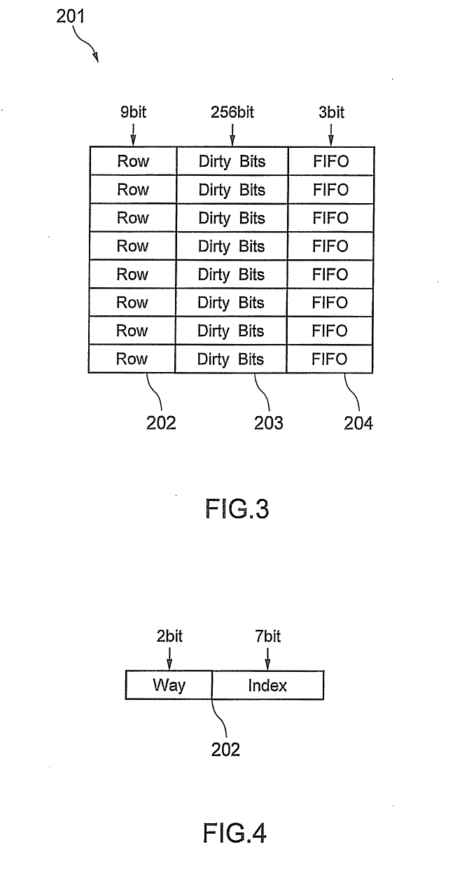

In addition, the cache memory 2 according to the present invention includes a DBLB (Dirty Bit Look-Up Block) management unit 201. FIG. 3 is a diagram showing a configuration example of the DBLB management unit 201. FIG. 4 is a diagram showing a configuration example of a row memory 202 in the DBLB management unit 201.

The DBLB management unit 201 includes the row memory 202 which stores data row to recognize a unique pertinent cache line, a dirty bit memory 203 which records a dirty bit of every byte in the data memory 105, and a FIFO memory 204. The dirty bits in the dirty bit memory 203 are bit information corresponding to writing into the data memory 105 with a byte taken as the unit.

In addition, the DBLB management unit 201 implements, for example, the First In First Out (FIFO) as an algorithm which determines a cache line to be expelled when overflow has occurred in the DBLB. The FIFO memory 204 stores FIFO information prescribing the order in which the line has been registered. For example, in the 8-entry DBLB structure, the FIFO information is represented in three bits. Note that the replacement scheme needs only be able to determine the replacement priority order between entries, and consequently it may be another scheme such as, for example, the LRU scheme.

The data row in the row memory 202 includes bit data which identifies a way and bit data which identifies a line index. At this point, the data row stores two bits which indicate one of ways from 0 to 4 and seven bits which indicate one of line indexes from 0 to 127, i.e., a total of nine bits.

Data in a certain cache line can be uniquely identified the pertinent line by the data row of the DBLB system.

The dirty bit memory 203 stores dirty bits associated with each data unit of data stored in the data memory 105. The data unit indicated by the dirty bits needs only be a unit which is smaller than the cache line size. Here, the data unit indicated by the dirty bits is determined to be a byte unit. In other words, 256 dirty bits are stored for 256-byte data.

It is now supposed that the cache memory 2 is requested to conduct write access of 8 bytes by the core 1 and a requested address has hit the cache memory 2. For example, the case in which a line index value “2” and a way value “0” are hit will now be described.

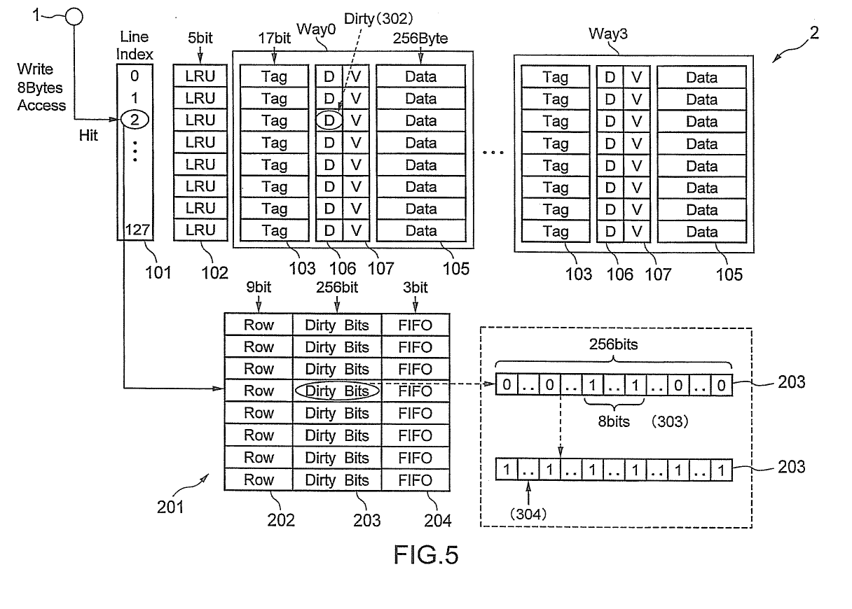

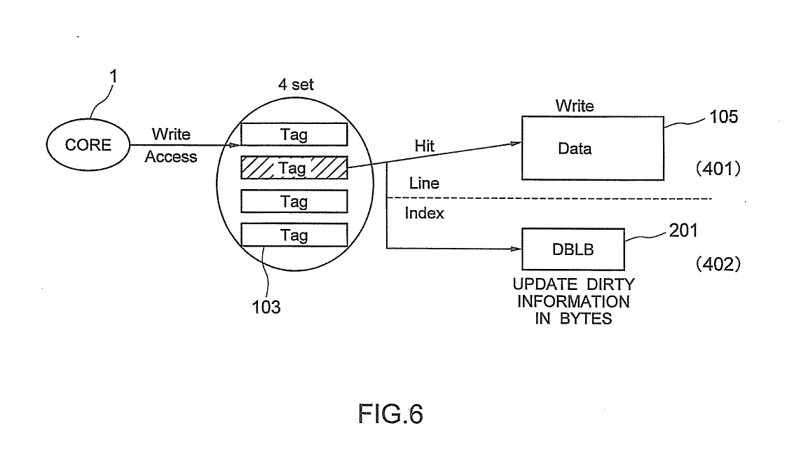

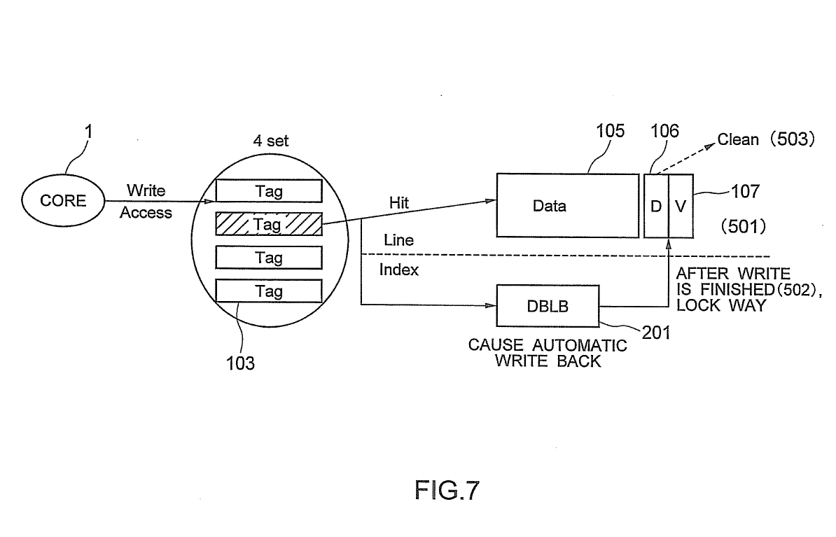

FIG. 5 is a diagram showing an example of the case where the cache memory 2 is requested to conduct write access by the core 1 and the requested address has hit. FIG. 6 is a diagram showing an example of pipeline processing conducted for the core 1 to access the cache memory 2 and pipeline processing in which the DBLB management unit 201 operates. FIG. 7 is a diagram showing an example of pipeline processing conducted for the core 1 to access the cache memory 2 and pipeline processing in which the DBLB management unit 201 operates.

If the cache memory 2 is requested to conduct write access of eight bytes by the core 1, then a tag address part of the requested retrieval entry address is compared with the tag address Tag in the tag memory 103.

As a result of the comparison, the line index “2” and the way “0” are hit. The cache memory 2 executes write operation on the data memory 105 in the way 0. At this time, the cache memory 2 sets the dirty bit D in the pertinent cache line to “1” (302). Furthermore, the cache memory 2 conducts comparison with data Row in the row memory 202 in the DBLB management unit 201 on the basis of the way value and the line index value which have caused a cache hit. If the same value exists, then the cache memory 2 judges that a DBLB hit has occurred.

Dirty bits (8 bits) that in the dirty bit memory 203 corresponding to 8-byte data to be written are made “1” (303). Until all dirty bits in the dirty bit memory 203 corresponding to a cache line subjected to write access have become “1,” the cache memory 2 does not generate automatic write back. In other words, when all dirty bits in the cache line subjected to the write access have become “1” (304), automatic write back of data cache line is conducted.

Note that in the present invention, writing (401) into the data memory 105 and update (402) of the dirty bits in the dirty bit memory 203 are executed in parallel (FIG. 6). Furthermore, the possibility that the core 1 conducts write access to the same cache line consecutively. The speed does not fall, compared to the case in which the core 1 conducts ordinary cache write access.

As for timing of the automatic write back occur, write back processing is waited until the write processing of the data cache is finished, in order to maintain the ordinary write access performance. On the basis of dirty bits in the dirty bit memory 203, (i.e., when writing has been conducted on the whole of the cache line corresponding to the dirty bits), the cache line is locked and write back of the corresponding cache line in the data memory 105 to the external memory 3 is conducted. If the write back is finished, all of the dirty bits in the corresponding cache line and the dirty bits in the DBLB management unit 201 are updated to “0.”

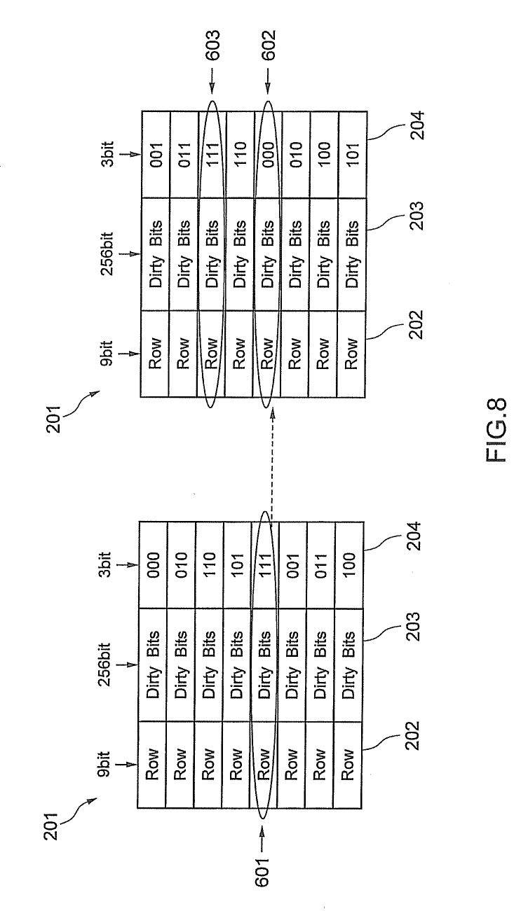

FIG. 8 is a diagram showing an example of operation when the cache line which has hit in the cache memory 2 does not exist (a DBLB miss) even if retrieval is conducted in the DBLB management unit 201. In some cases, a cache line which has hit in the cache memory 2 does not exist even if retrieval is conducted in the DBLB management unit 201.

If there are no vacancies in the DBLB, replacement of lines in the DBLB management unit 201 is conducted. In the present embodiment, a FIFO algorithm which determines, for example, a line which is the oldest in registration order to be a line to be replaced. The line to be replaced is determined on the basis of a FIFO value stored in the FIFO memory 204. The line to be replaced is a line having the greatest value “111” in FIFO value (i.e., the oldest registered line) (601) (FIG. 8(a)). Information of a new cache line is registered in this line. The Row in the line to be replaced is updated to a value corresponding to the way and line index in the new cache line. At the same time, dirty bits are also updated to a value corresponding to the data state in the new cache line. Then, 1 is added to the FIFO in every line in the DBLB management unit 201. The FIFO value in the line to be replaced is set to “000” (FIG. 8(b)).

Note that if there is a vacancy in the DBLB management unit 201, predetermined data is stored in the row memory 202, the dirty bit memory 203 and the FIFO memory 204 of the vacant line.

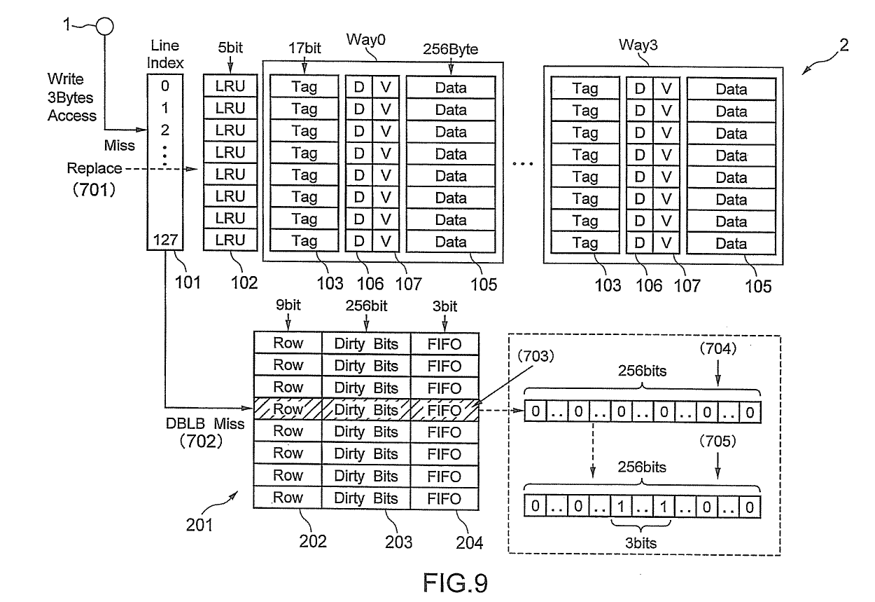

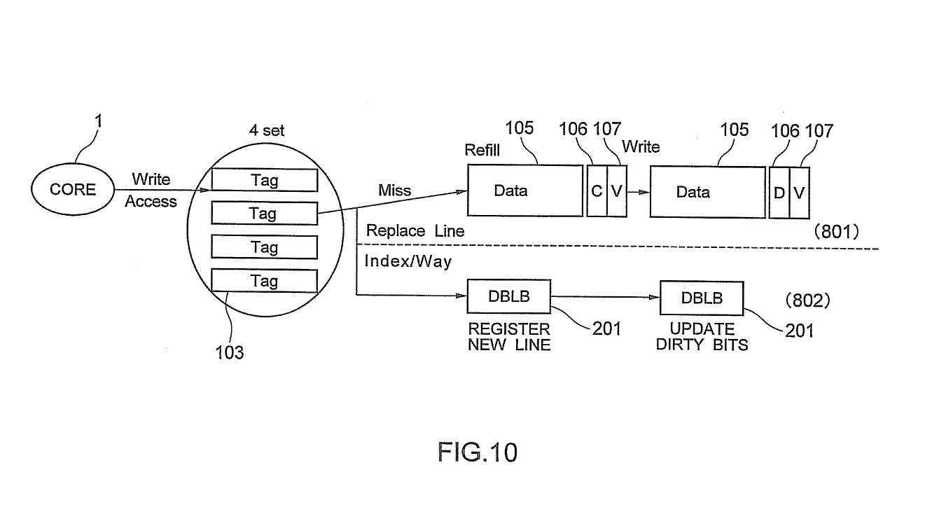

On the other hand, when conducting write access from the core 1 to the cache memory 2, a cache miss occurs in some cases. The operation of the DBLB management unit 202 which is conducted when a cache miss has occurred will now be described. FIG. 9 is a diagram showing an example of operation of the DBLB management unit 202 when a cache miss occurs. FIG. 10 is a diagram showing another example of pipeline processing in which the core 1 accesses the cache memory 2 and pipeline processing in which the DBLB management unit 201 operates.

When a cache miss has occurred, refill access of that address is requested from the external memory 3 and a replace entry (701) cache line is determined. The fetched data supplied from the external memory 3 is written into the entry to be replaced, and then data write request from the core 1 is executed. Note that if write back of existing data stored in that entry is required, the address and data are contained in a write buffer (not illustrated). Thereafter, write access is requested from the external memory 3, and data write back is conducted.

If a cache miss has occurred, then a corresponding tag address Tag does not exist, and consequently a miss operation occurs in the DBLB management unit 201 as well (a corresponding line does not exist in the row memory 202) (702). If there is no vacancy in the DBLB management unit 201, therefore, a line to be replaced is determined (703) and all dirty bits on this line are cleared (704) to 0. If there is a vacancy, data is registered into the vacant line as new information. When executing data write requested by the core 1 into the cache memory 2, corresponding to the write bytes information, the dirty bits of the line are updated (705).

Operation timing of the DBLB management unit 201 shown in FIG. 9 will now be described. If a cache miss has occurred in the cache memory 2, a number of a way to be replaced is determined and then refilling is generated in the cache memory 2.

Thereafter, overwrite processing in the cache memory 2 conducted from the core 1, registration of a new line in the DBLB management unit 201, and update processing of dirty bits caused by write access from the core 1 are executed in parallel.

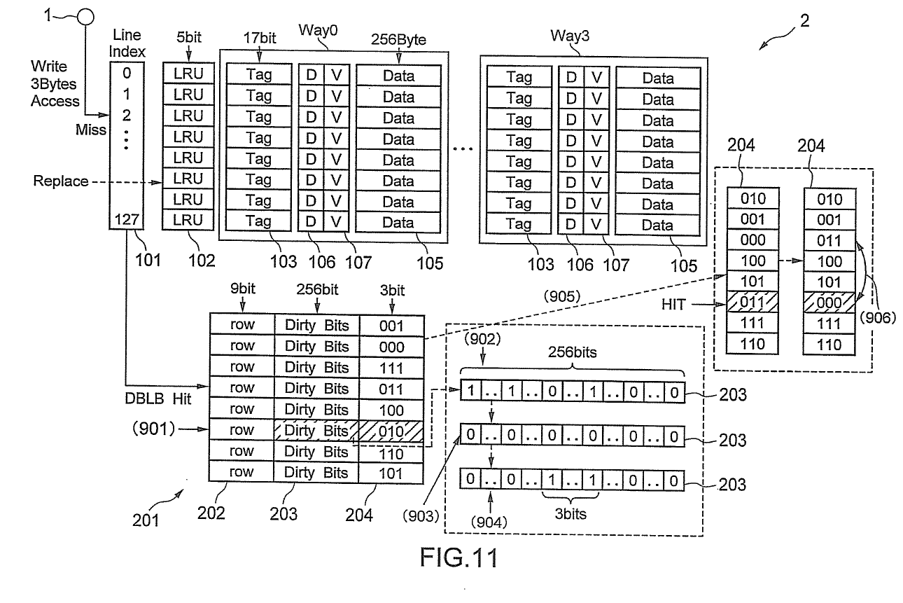

When a line index and a way to be expelled are determined when a cache miss has occurred, values of the line index and the way coincide with bits in the row memory 202 in some cases. Hereafter, operation in this case will be described with reference to FIG. 11.

It is now supposed that a cache miss occurs and an entry to be replaced is determined. If the entry is already registered in the DBLB management unit 201 (901), then dirty bits on this line become dirty bits (902) on the old line.

Therefore, all dirty bits are cleared (903), write data supplied from the core 1 is written into the cache memory 2, and dirty bits in the DBLB management unit 201 are updated (904).

Note that since there is no new registered line into the DBLB management unit 201, the FIFO value may not be updated. However, the FIFO value may be updated in order to raise the hit ratio in the DBLB management unit 201. For example, “1” is added to the FIFO value in every entry (905). The FIFO value (which is “011” in FIG. 11) in the hit line is replaced by a FIFO value of an entry which has returned to “000” (906). As a result, the earliest registered line will be replaced and later information is registered in the DBLB management unit 201.

If a cache miss has occurred to write access in the cache memory 2 in this way, then a new line corresponding to a cache line to be refilled is replaced with the line registered the earliest in the DBLB management unit 201.

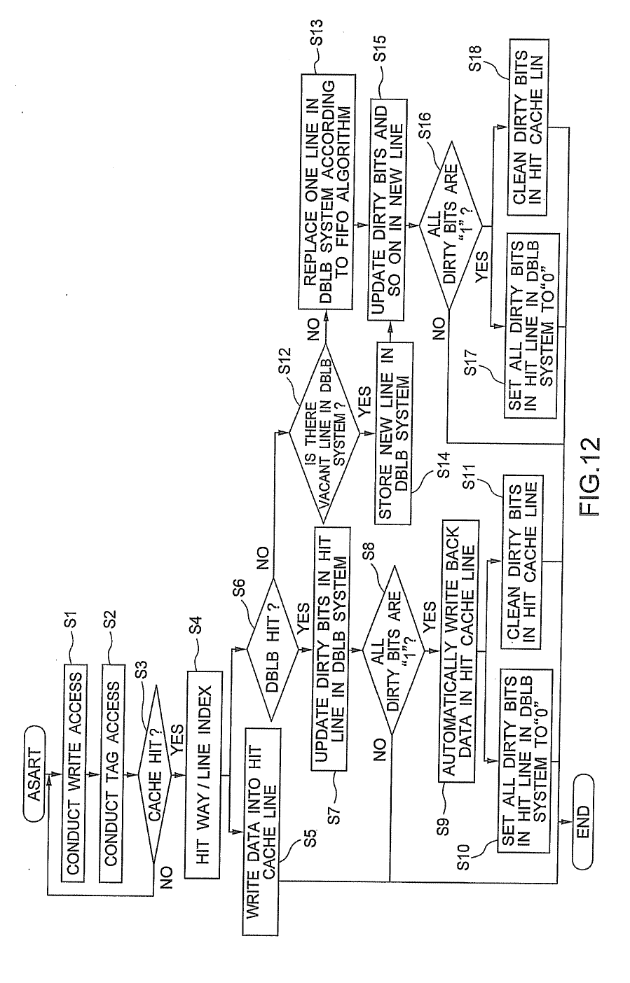

Operation of the cache memory 2 having the function described heretofore will be described collectively. FIG. 12 is a flow chart showing an example of operation of the cache memory 2 in the present invention. First, upon being subject to write access from the core 1 (S1), the cash memory 2 refers to the tag memory 103 (S2).

The tag address part in the retrieval entry address is compared with tag addresses Tag in the tag memory 103 (S3). Upon coincidence, a cache hit is judged to have occurred. Upon the coincidence, the way and line index are obtained from the coincident tag address Tag (S4).

Write data is written into the data memory 105 of a cache line of the obtained way (S5). Furthermore, a decision is made whether bit information in the row memory 202 in the DBLB management unit 201 coincides with the way and line index of the tag address Tag which is hit (S6). Note that operations at S5 and S6 are conducted in parallel. Upon coincidence at S6 (S6—Yes), pertinent bits in the hit line in the DBLB management unit 201 are updated (S7).

Then, the cache memory 2 makes a decision whether all dirty bits in the pertinent line in the DBLB management unit 201 have become “1” (S8). If all dirty bits are judged to be “1” (S8—Yes), automatic write back is executed (S9).

On the other hand, if all dirty bits are not “1” (S8—No), the processing is finished without conducting write back.

Then, after S9, all of dirty bits in the cache line which is hit and dirty bits in the hit line in the DBLB management unit 201 are updated to “0” (S10).

If bit information in the row memory 202 in the DBLB management unit 201 does not coincide with the way and line index in the hit tag address Tag (S6—No), a decision is made whether there is a vacant line in the DBLB management unit 201 (S12).

If there is no vacant line (S12—No), line replacement in the DBLB management unit 201 is conducted (S13). On the other hand, if there is a vacant line (S12—Yes), information of the new line is stored in the vacant line in the DBLB system (S14).

After S13 and S14, bit information and dirty bits in the new line in the DBLB management unit 201 are updated (S15). In other words, bits in the row memory 202 are rewritten to be values corresponding to the way and line index in a cache line corresponding to the new line. Furthermore, the dirty bit memory 203 is updated with dirty bits corresponding to the data state in the cache line which corresponds to the new line.

Then, the cache memory 2 makes a decision whether all dirty bits in the dirty bit memory 203 of the new line in the DBLB management unit 201 are “1” (S16). If all of dirty bits are “1” (S16—Yes), then all of the dirty bits in the hit cache line and dirty bits in the new line in the DBLB management unit 201 are updated to “0” (S17). On the other hand, if all of them are not “1” (S16—No), then the processing is finished.

Note that if a bit in the dirty bit memory 106 is dirty when executing a flash instruction of the core 1, then the cache memory 2 conducts write back to the external memory 3. In this case, the entirely the same operation as that in the ordinary cache memory is conducted. In the present invention, however, a line which originally needs write back is also already subjected to write back automatically in some cases, and consequently the flash instruction can be finished more early. If the line index and way in the cache memory 2 at an address to be flashed exist in the row memory 202 in the DBLB management unit 201, then all dirty bits in the pertinent entry are set to “0.”

In the embodiment of the present invention, write back can be conducted automatically when all dirty bits in one entry in the DBLB management unit 201 have become “1,” i.e., all bytes in the corresponding cache line have become dirty. Therefore, a phenomenon that the write back is conducted although a clean byte still remains can be suppressed and wasteful bandwidth dissipation to the global bus can be reduced.

Since such accesses as to write over the whole of a determinate area are basically conducted collectively, the area increase of the cache memory 2 can be suppressed by providing a dedicated cache (DBLB management unit 201) which retains dirty bits by taking a byte as the unit. The pipeline processing conducted by operation of the DBLB management unit 201 exerts the least influence upon the speed of cache access, according to it operates in pipeline processing which is completely different from that of the ordinary cache memory.

In hardware implementation as well, the logic of the DBLB system can be easily attached to the conventional cache memory. The DBLB management unit 201 in the embodiment of the present invention is eight in the number of entries in the DBLB and has 268 bits (approximately 34 bytes) in one line and becomes very small (in the range of 1.6% to 0.204%) in area as compared with the cache memory (in the range of 64 to 512 by 260 bytes). In addition, dynamic power decrease owing to the decrease of wasteful data write back access can be expected. Furthermore, the DBLB management unit 201 is a system which is little in overhead, which can be implemented easily, and which is sufficiently efficient as compared with the conventional technique.

According to the cache memory in the embodiment of the present invention, the speed can be increased while suppressing the area increase as heretofore described.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A cache memory comprising:
one or a plurality of ways having a plurality of cache lines including a tag memory which stores a tag address, a first dirty bit memory which stores a first dirty bit, a valid bit memory which stores a valid bit, and a data memory which stores data;
a line index memory which stores a line index for identifying the cache line; and
a DBLB management unit having a plurality of lines including a row memory which stores first bit data identifying the way and second bit data identifying the line index, a second dirty bit memory which stores a second dirty bit of bit unit corresponding to writing of a predetermined unit into the data memory, and a FIFO memory which stores FIFO information prescribing a registered order,
wherein data in a cache line of a corresponding way is written back on the basis of the second dirty bit.

2. The cache memory according to claim 1, wherein data in a cache line of the corresponding way being written back when it is indicated that all bits of the second dirty bit have been written.

3. The cache memory according to claim 1, wherein processing in the DBLB management unit is executed in parallel with processing of writing into the data memory.

4. The cache memory according to claim 1, wherein if there isn't a vacancy in the lines, the DBLB management unit clears a line registered the most earlier on the basis of the FIFO information, and updates the second dirty bit and the FIFO information as a new line.

5. The cache memory according to claim 4, wherein if a corresponding line is not hit in the DBLB management unit when a cache miss occurs for write access, the DBLB management unit clears a line registered the most earlier and replaces it with a new line corresponding to a cache line to be refilled, on the basis of the FIFO information.

6. The cache memory according to claim 1, wherein if a corresponding line is hit in the DBLB management unit when a cache miss occurs for write access, the DBLB management unit clears the second dirty bit in the hit line and conducts updating.

7. The cache memory according to claim 6, wherein the FIFO information in the updated line is updated as a latest value.

8. The cache memory according to claim 1, wherein the cache memory is formed by using an SRAM.

9. A cache system comprising:
a core;
a cache memory connected to the core via bus; and
an external memory connected to the cache memory via the bus,
wherein the cache memory comprising:
one or a plurality of ways having a plurality of cache lines including a tag memory which stores a tag address, a first dirty bit memory which stores a first dirty bit, a valid bit memory which stores a valid bit, and a data memory which stores data;
a line index memory which stores a line index for identifying the cache line; and
a DBLB management unit having a plurality of lines including a row memory which stores first bit data identifying the way and second bit data identifying the line index, a second dirty bit memory which stores a second dirty bit of bit unit corresponding to writing of a predetermined unit into the data memory, and a FIFO memory which stores FIFO information prescribing a registered order,
wherein data in a cache line of a corresponding way is written back on the basis of the second dirty bit.

10. The cache system according to claim 9, wherein data in a cache line of the corresponding way being written back when it is indicated that all bits of the second dirty bit have been written.

11. The cache system according to claim 9, wherein processing in the DBLB management unit is executed in parallel with processing of writing into the data memory.

12. The cache system according to claim 9, wherein if there isn't a vacancy in the lines, the DBLB management unit clears a line registered the most earlier on the basis of the FIFO information, and updates the second dirty bit and the FIFO information as a new line.

13. The cache system according to claim 12, wherein if a corresponding line is not hit in the DBLB management unit when a cache miss occurs for write access, the DBLB management unit clears a line registered the most earlier and replaces it with a new line corresponding to a cache line to be refilled, on the basis of the FIFO information.

14. The cache system according to claim 9, wherein if a corresponding line is hit in the DBLB management unit when a cache miss occurs for write access, the DBLB management unit clears the second dirty bit in the hit line and conducts updating.

15. The cache system according to claim 14, wherein the FIFO information in the updated line is updated as a latest value.

16. The cache system according to claim 9, wherein the cache memory is formed by using an SRAM.
